(19) United States
(12) Patent Application Publication
(10) Pub. No.: US 2025/0088285 A1
(43) Pub. Date: Mar. 13, 2025

(54) METHOD AND APPARATUS FOR CHROMATIC DISPERSION COMPENSATION

(71) Applicant: Infinera Corporation, San Jose, CA (US)

(72) Inventors: Nashat Abughalieh, Kanata (CA); Mohamed Osman, Kanata (CA); Joon Ho Cho, Holmdel, NJ (US); Han Henry Sun, Kanata (CA)

(21) Appl. No.: 18/829,275

(22) Filed: Sep. 9, 2024

Related U.S. Application Data
(60) Provisional application No. 63/537,308, filed on Sep. 8, 2023.

(51) Int. Cl. H04B 10/61

(52) U.S. Cl. CPC H04B 10/6161

(57) ABSTRACT

The present invention provides new apparatus and methods for chromatic dispersion compensation.

### RELATED APPLICATION

This application is related to and claims priority to U.S. Provisional Patent Application No. 63/537,308, “Sub-band Chromatic Dispersion Equalizer (CDEQ),” filed Sep. 8, 2023, which is incorporated by reference herein.

### FIELD OF THE DISCLOSURE

The present invention relates to the field of optical networking, and more specifically to the field of chromatic dispersion compensation.

### BACKGROUND

Chromatic dispersion is an important phenomenon in the context of optical networking. Chromatic dispersion occurs when different wavelengths of light in a beam arrive at a destination at different points in time. This can be due at least in part for example to the fact that the velocity of light is wavelength-dependent. Any optical transport-related spreading, or dispersion, of the binary on-off light pulses that convey digital information can for example make the binary signals (1 s and 0 s) more difficult to distinguish from each other at a distant or receiving end of the fiber. Chromatic dispersion therefore is a serious consideration, including for example in long-haul optical fiber networks.

Existing techniques have been developed in the field of optical networking to help address the negative effects of chromatic dispersion. Techniques such as these can be characterized generally as chromatic dispersion compensation techniques. For example, chromatic dispersion compensation is sometimes referred to as chromatic dispersion equalization, for example in the context of helping to correct or reverse, or compensate, for chromatic dispersion that has already occurred in a given signal (e.g., a received signal). Chromatic dispersion compensation is also sometimes referred to as chromatic pre-dispersion or pre-compensation (hereinafter, “pre-dispersion”), for example in the context of helping to correct or reverse, or compensate, for chromatic dispersion that hasn't yet occurred but is anticipated will occur within the network, such as for example chromatic pre-dispersion that may be performed within a transmitter on a signal to be transmitted to an optical network. Chromatic pre-dispersion may also be considered a form of chromatic dispersion equalization, and vice versa.

Among the existing techniques have been developed are for example solutions described by I. Slim, A. Mezghani, L. G. Baltar, J. Qi, F. N. Hauske and J. A. Nossek, “Delayed Single-Tap Frequency-Domain Chromatic-Dispersion Compensation,” in IEEE Photonics Technology Letters, Vol. 25, No. 2, Jan. 15, 2013, pp. 167-170 (hereinafter, “Slim et al.”). Contrary to other existing techniques for chromatic dispersion compensation developed by others, Slim et al. proposes a frequency-domain (FD) filtering approach based on a nonmaximally decimated discrete Fourier transform filter bank with a trivial prototype filter and a delayed single-tap equalizer per sub-band. Although this approach dramatically increases chromatic dispersion tolerance without increasing the complexity of implementation, at least according to the authors, the present inventors have recognized that this and other exiting approaches to chromatic dispersion compensation have their deficiencies.

### BRIEF DESCRIPTION OF THE DRAWINGS

The accompanying drawings, which are incorporated in and constitute a part of this specification, illustrate one or more example embodiments described herein and, together with the description, describe these implementations. The drawings are not intended to be drawn to scale, and certain features and certain views of the figures for example may be shown exaggerated, and/or otherwise not-to-scale, and/or in schematic form, in the interest of clarity and conciseness. Not every component may be labeled in every drawing. Like reference numerals in the figures may represent and refer to the same or similar element or function, even though such elements or functions may be non-identical from one figure or example embodiment to another figure or example embodiment. In the drawings:

FIG. 1 is a block diagram schematically depicting an example embodiment of a representative transmit-and-receive, single-carrier optical signal networking system, including without limitation example embodiments of a coherent optical transmitter and of a coherent optical receiver.

FIG. 2 is a schematic block diagram further depicting an example embodiment of a receiver digital signal processor (DSP), including example sub-band chromatic dispersion equalizer engines (CDEQs) and certain other components thereof, that belongs to the coherent DSP depicted within the optical receiver of FIG. 1.

FIG. 3 is a schematic block diagram further depicting an example embodiment of the sub-band chromatic dispersion equalizer engine (CDEQ) of the receiver DSP depicted in FIG. 2.

FIG. 4A is a representative spectra plot illustrating example sub-band chromatic dispersion equalizer engine (CDEQ) operation of the CDEQ depicted in FIG. 3.

FIG. 4B is a portion of the spectra plot of FIG. 4A, zoomed in on a representative three sub-bands of the spectra plot to more clearly illustrate the sub-band overlap between adjacent sub-bands across the plot.

FIG. 5 is a schematic block diagram further depicting an example embodiment of a rotation multiplier represented by any given one of the ROT blocks in the sub-band chromatic dispersion equalizer engine (CDEQ) of FIG. 3.

FIG. 6 is a schematic block diagram further depicting an example embodiment of a set of static direct multipliers representing any given one of the Qm blocks in the sub-band chromatic dispersion equalizer engine (CDEQ) of FIG. 3.

FIG. 7 is a schematic block diagram further depicting an example embodiment of a set of W′ programmable Direct (D)/Hermitian (H) (Dₘ/Hₘ) multipliers representing any given one of the sets of programmable Dₘ/Hₘ multipliers in the sub-band chromatic dispersion equalizer engine (CDEQ) of FIG. 3.

FIG. 8 is another block diagram schematically depicting an example embodiment of a representative transmit-and-receive, single-carrier optical signal networking system, including without limitation example embodiments of a coherent optical transmitter and of a coherent optical receiver.

FIG. 9 is a schematic block diagram further depicting an example embodiment of a transmitter digital signal processor (DSP), including example sub-band chromatic dispersion equalizer engines (CDEQs) and certain other components thereof, that belongs to the coherent DSP depicted within the optical transmitter of FIG. 8.

FIG. 10 is another block diagram schematically depicting an example embodiment of a coherent optical transceiver comprising both a coherent optical transmitter and of a coherent optical receiver.

FIG. 11A is a first portion of a two-portion flow diagram that spans both FIGS. 11A and 11B, the flow diagram representing various steps of an example embodiment of the present invention.

FIG. 11B is a second portion of a two-portion flow diagram that spans both FIGS. 11A and 11B, the flow diagram representing various steps of an example embodiment of the present invention.

FIG. 12 is a flow diagram representing an example configuration used in traditional chromatic dispersion equalization techniques.

### DETAILED DESCRIPTION

The inventors of the present invention have recognized the opportunity to provide improved apparatus and methods for chromatic dispersion compensation, including for example but without limitation new and useful apparatus and methods to achieve cost-effective, high-performing solutions in small-scale, low-power environments.

The following detailed description of example embodiments and implementations refers to the accompanying drawings. The same reference numbers in different drawings may identify the same or similar elements.

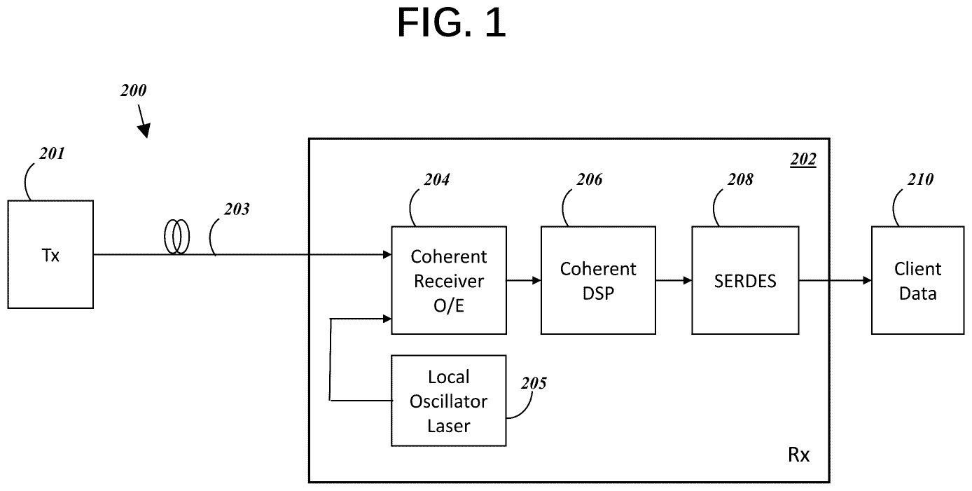

FIG. 1 is a block diagram schematically depicting an example embodiment of a representative transmit-and-receive, single-carrier optical signal networking system, including without limitation example embodiments of a coherent optical transmitter 201 and of a coherent optical receiver 202. The coherent optical receiver 202 comprises traditional receiver components, such as for example local oscillator laser 205, coherent receiver O/E 204, coherent DSP 206 and SERDES 208. The coherent optical receiver 202 for example facilitates communication of client data 210 transmitted by coherent optical transmitter 901 across one or more optical fiber 203.

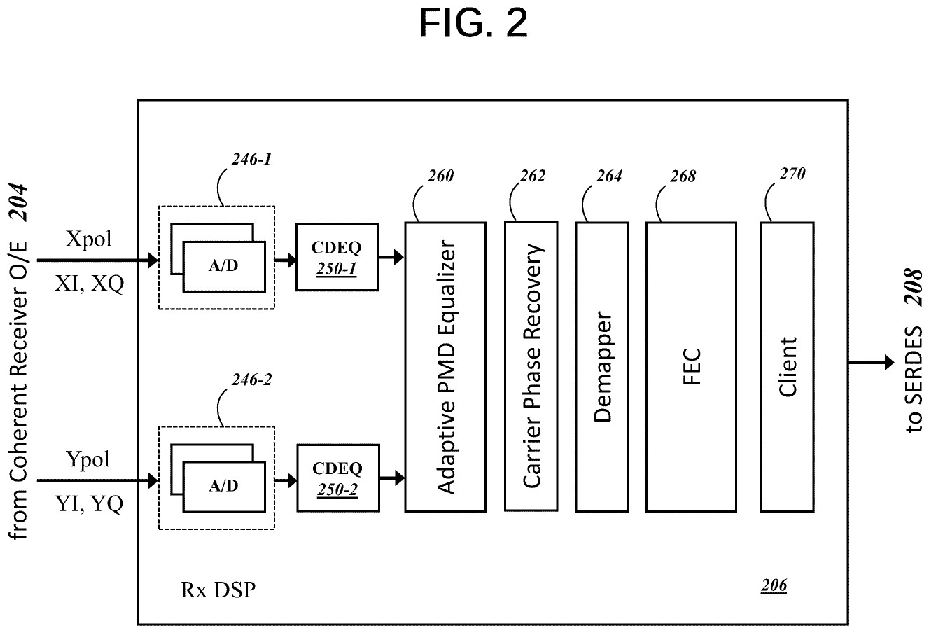

FIG. 2 is a schematic block diagram further depicting an example embodiment of a receiver digital signal processor (DSP), including example sub-band chromatic dispersion equalizer engines (CDEQs) 250-1 and 250-2 and certain other components thereof that are of a conventional nature, that belongs to the coherent DSP 206 depicted within the coherent optical receiver 202 shown in FIG. 1. Such other components include for example the client processing circuit 970, the forward error correction circuit (FEC) 968, the mapper 264, the pulse shaper 962, and A/D converters 246-1 and 246-2, the adaptive PMD equalizer 260, the carrier phase recovery circuit 262, the demapper 264, the forward error correction circuit (FEC) 268, and the client processing circuit 270.

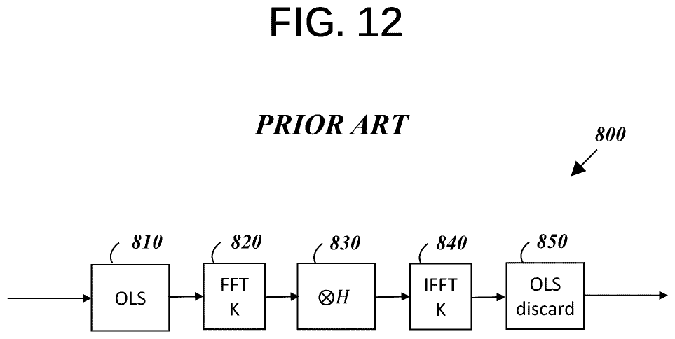

Traditional chromatic dispersion equalization techniques, such as for instance the configuration 800 shown in FIG. 12, may for example employ an overlap-and-save (OLS) buffer 810, an FFT 820 of size K, a coefficient multiplier 830, an IFFT 840 of size K, and an OLS discard buffer 850, as components of a given coherent optical receiver. OLS buffer 810 may receive from A/D converters (not shown) digital samples of complex signals received by the coherent optical receiver. Configuration 800 for example compensates for dispersion using FFT 820 of size K, coefficient multiplier 830, and an IFFT 840 of size K. OLS buffer 810 serves, using traditional input sample overlap techniques, to enable the FFT 820 to form the necessary linear convolutions for configuration 800, and in a cooperating manner OLS discard buffer 850 in turn discards, again using traditional techniques, certain of the samples.

Solutions such as configuration 800, however, are not ideal for example in applications in which a DSP is a component of a low-power, small-size device, such as for example a pluggable optical transceiver. This is especially true if such a DSP is for example tasked to perform large amounts of chromatic dispersion compensation using traditional chromatic dispersion equalization techniques, which may require very large-sized FFT and IFFT components. Large-sized FFT and IFFT components for example may, at least for certain applications such as for example pluggable optical transceivers, lead to design problems such as for example unduly large circuit sizes, leakage, and power requirements. The inventors of the present invention recognized for example the value that may be presented by an alternative solution that allows smaller FFT and IFFT sizes to be employed, as compared to more traditional techniques, to achieve comparable amounts of chromatic dispersion equalization.

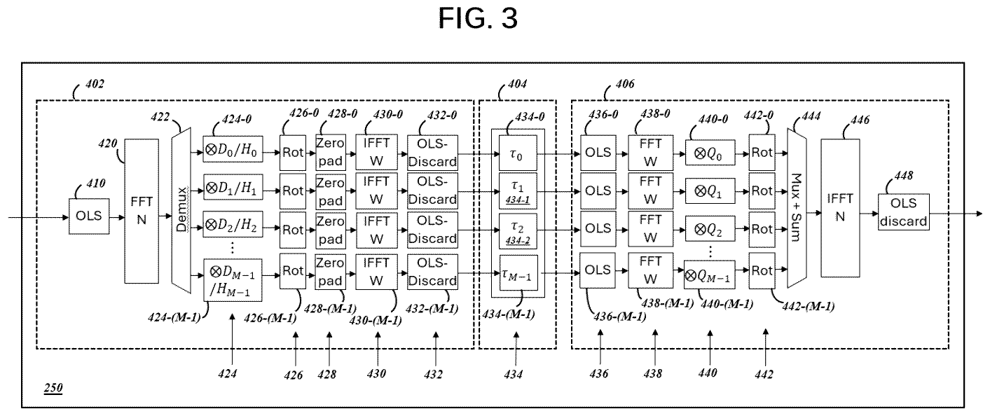

Turning now to FIG. 3, disclosed is a schematic block diagram further depicting an example embodiment of a sub-band chromatic dispersion equalizer engine (CDEQ) according to the present invention, such as for example either of the two illustrated CDEQs 250 of the receiver DSP 206 depicted in FIG. 2. Although the below description of FIG. 3 opts to describe CDEQ 250 in the representative context of CDEQ 250-1, and its processing of received signals XI and XQ, it will be understood by those skilled in the art that CDEQ 250-2 of the receiver DSP 206 is constructed similarly to CDEQ 250-1, and also operates with respect to the processing of received signals YI and YQ in a manner that is similar to the operation of CDEQ 250-1 with respect to the processing of received signals XI and XQ. From this disclosure it also will be understood by those skilled in the art that the present invention is not limited to coherent receiver applications.

In the example coherent optical receiver embodiment of FIGS. 1-3, signals of a given one of the two polarization states (e.g., XI and XQ, in the case of CDEQ 250-1), output from the coherent receiver O/E 204, are received at the receiver DSP 206 as shown in FIG. 2. This coherent receiver O/E 204 output that is received at the receiver DSP 206 is A/D converted at the respective A/D converters 246 (e.g., A/D converters 246-1, in the case of XI and XQ) and then received at the respective CDEQ 250 (e.g., CDEQ 250-1).

Within the CDEQ 250, the signals are received by a first overlap-save (OLS) buffer 410 of an analysis bank portion 402 of the CDEQ 250 as shown in FIG. 3. The OLS buffer 410 operates to introduce an amount of overlap between a given two consecutive FFT operations of length N samples, depending on the set OLS ratio (sometimes also referred to as OLS mode) of the analysis bank portion 402. For example, a first of a given two consecutive FFT operations performed by the FFT-N 420 described below may use samples 0 to 2047 if for example the FFT-N 420 is a 2048-point FFT, and a second of the given two consecutive FFT operations performed by the FFT-N 420 uses samples 1536 to 3583. From this example it is evident that samples from 1536 to 2047 in this instance are used in both of the two consecutive FFT operations, resulting in an overlap of 512 samples. In this example, this amount of overlap corresponds to an OLS ratio of 512/2048=¼ (or 0.25). Regardless of the size (i.e. point) that is selected for the FFT-N 420, the preferred OLS ratio is less than ½ (or 0.50), and preferably for example ¼ (or 0.25) or ⅛ (or 0.125), which further minimizes power. Furthermore, this OLS ratio preference (namely, for an OLS ratio of less than ½ (or 0.50)) applies to both the OLS ratio selected for the analysis bank portion 402 and the OLS ratio selected for the synthesis bank portion 406 (which such synthesis bank portion 406 is introduced and described further below).

Other example OLS ratios may include for example and without limitation ratios or modes having values equal to 0.125 or 0.375. The same OLS ratio to which the OLS buffer 410 is set is preferably also used to set other functional components of the analysis bank portion 402 of CDEQ 250, such as for example the number (M) of rotation blocks 426-0 through 426-(M−1) and the number (M) of OLS discard blocks 432-0 through 432-(M−1). The same OLS ratio to which the OLS buffer 410 is set also may be used in setting functional components of the synthesis bank portion 406 of CDEQ 250, such as for example the number (M) of OLS buffers 436-0 through 436-(M−1), the number (M) of static direct multipliers 440-0 through 440-(M−1), and the number (M) of rotation blocks 442-0 through 442-(M−1), each of which will be further described below.

Continuing from left to right in FIG. 3, the FFT-N 420 and frequency demultiplexer (demux) 422 operate to select a pre-determined range of W′ frequency bins for each one (m) of a total number (M) of sub-bands to be further processed by CDEQ 250. The FFT-N 420 of CDEQ 250 may be for example notably smaller than the FFT 820 of size K described above in the context of traditional chromatic dispersion equalization techniques (i.e., N<K), to achieve comparable amounts of chromatic dispersion equalization. The total number (M) of sub-bands the CDEQ 250 is to be tasked with processing for a given application may be determined for example based on a given total amount of dispersion compensation that is targeted for a given application, with the understanding that an inherent dispersion compensation amount limit associated with a FFT-N 420 of a given size N may in turn operate to dictate this total number (M).

After the demux 422, CDEQ 250 comprises a number (M) of sets of programmable Dₘ/Hₘ multipliers 424-0 through 424-(M−1), such that there is one set of programmable multipliers 424-m for each respective one (m) of the M number of sub-bands the CDEQ 250 is tasked with processing. Accordingly, although four sets of programmable multipliers 424-m are illustrated in FIG. 3, it should be understood that example embodiment CDEQ 250 may for example comprise more than four sets of programmable multipliers 424-m, if for example CDEQ 250 is to process more than four sub-bands (i.e., M>4), insofar as the number of programmable multipliers 424-m illustrated FIG. 3 is merely representative, so as to simplify the diagram and in turn engender clarity. Notwithstanding the representative nature of FIG. 3, the example embodiment contemplates that the total number of programmable multipliers 424-m is in practice selected to match the select total number (M) of sub-bands that CDEQ 250 is tasked with processing.

The sets of programmable Dₘ/Hₘ multipliers 424-0 through 424-(M−1) are together represented in FIG. 3 by block array 424, wherein each set of programmable multipliers 424-m within the block array 424 is represented by a respective programmable multiplier block 424-m. For clarity of FIG. 3, not all of the programmable multiplier blocks within the vertically depicted block array 424 are labeled with a reference numeral, however it nevertheless shall be understood that each depicted programmable multiplier block within the illustrated block array 424 represents yet another programmable multiplier block 424-m, or set of programmable Dₘ/Hₘ multipliers 424-m, among the sets of programmable Dₘ/Hₘ multipliers 424-0 through 424-(M−1).

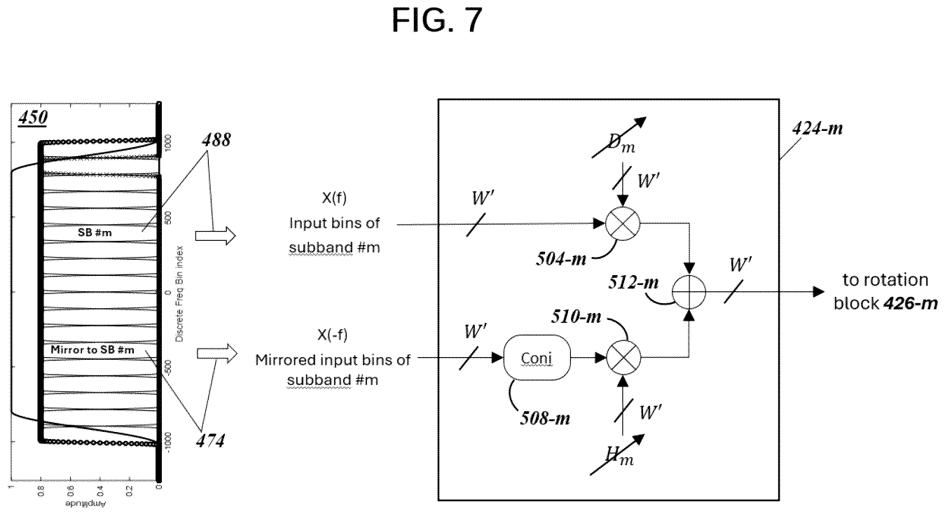

Each programmable Dₘ/Hₘ multiplier block 424-m represents a set of programmable multipliers comprising W′≤W direct multipliers, denoted Dₘ in a given block 424-m among the programmable multiplier block array 424, and thus programmable multiplier block array 424 comprises multiple sets of programmable direct multipliers, collectively denoted {D₀, D₁, . . . . D_{M-1}}. Each programmable Dₘ/Hₘ multiplier block 424-m also represents a set of programmable multipliers comprising W′≤W Hermitian multipliers, denoted Hₘ in a given block 424-m among the programmable multiplier block array 424, and thus programmable multiplier block array 424 comprises multiple sets of programmable Hermitian multipliers, collectively denoted {H₀, H₁, . . . . H_{M-1}}. A representative set of programmable Dₘ/Hₘ multipliers 424-m is illustrated schematically for example in FIG. 7, as will be further discussed below. Each set of programmable Dₘ/Hₘ multipliers 424-m serves to compensate, at least in part, for chromatic dispersion within its sub-band (m).

Continuing from left to right in the analysis bank portion 402 of the CDEQ 250, next is a block array 426 representing a number (M) of rotation blocks 426-0 through 426-(M−1) such that, similar to block array 424 discussed above, there is one rotation block 426-m for each respective one (m) of the M number of sub-bands. Also like block array 424, while not all of blocks within the vertically depicted block array 426 shown in FIG. 3 are labeled with a reference numeral, it shall be understood that each depicted block within the illustrated block array 426 represents yet another rotation block 426-m among the rotation blocks 426-0 through 426-(M−1). Each rotation block 426-m in this embodiment may introduce a pre-determined phase shift to the given sub-band (m) for which the rotation block 426-m is responsible.

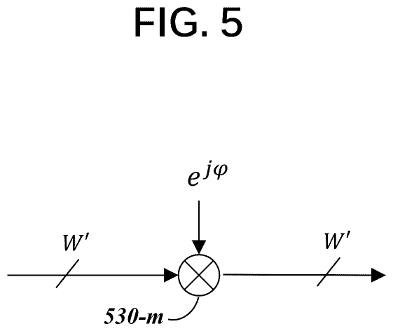

A representative rotation multiplier 530-m that a given rotation block 426-m may represent is shown for example in FIG. 5. The amount of pre-determined phase rotation, or shift, introduced to a given sub-band (m) by the corresponding rotation block 426-m may vary from one sub-band to another, and for example may be determined based on one or more dependencies that for instance may include without limitation the center frequency bin of the given sub-band (m) and the applied OLS ratio. Depending on the center frequency bin allocation of the given sub-band (m) and the select OLS ratio, there can be phase discontinuities generated between successive FFT operations on a sub-band signal, whereupon the rotation block 426-m can be used to fix the phase discontinuities. The amount of pre-determined phase shift introduced to a given sub-band (m) by the corresponding rotation block 426-m may also differ from the amount of pre-determined phase shift introduced to the same sub-band (m) by the corresponding rotation block 442-m that is discussed further below, if for example the OLS ratio used to set the analysis block portion 402 is different than the OLS ratio used to set the synthesis block portion 406.

Progressing further from left to right in the analysis bank portion 402 of the CDEQ 250 shown in FIG. 3, next is a block array 428 representing a number (M) of zero-pad blocks 428-0 through 428-(M−1) such that, similar to block arrays 424 and 426 discussed above, there is one zero-pad block 428-m for each respective one (m) of the number (M) of sub-bands. Also like block arrays 424 and 426, while not all of blocks within the vertically depicted block array 428 shown in FIG. 3 are labeled with a reference numeral, it shall be understood that each depicted block within the illustrated block array 428 represents yet another zero-pad block 428-m among the zero-pad blocks 428-0 through 428-(M−1). Each zero-pad block 428-m in this embodiment may zero pad the W′ bins of the given sub-band (m) for which the zero-pad block 428-m is responsible, if for example W′S W, so that the given sub-band (m), as introduced to the succeeding IFFT-W block 430-m described below, has a number W bins instead of a lesser number W′ bins. Of course, if for example in certain instances W′ instead equals W, then no zero padding need be introduced intermediate the rotation block 426-m and the IFFT-W block 430-m.

Block array 430 of the analysis bank portion 402 represents a number (M) of IFFT-W blocks 430-0 through 430-(M−1) such that, similar to block arrays 424, 426 and 428 discussed above, there is one IFFT-W block 430-m for each respective one (m) of the M number of sub-bands. Also like block arrays 424, 426 and 428, while not all of blocks within the vertically depicted block array 430 shown in FIG. 3 are labeled with a reference numeral, it shall be understood that each depicted block within the illustrated block array 430 represents yet another IFFT-W block 430-m among the IFFT-W blocks 430-0 through 430-(M−1). Each IFFT-W block 430-m in this embodiment may be used to convert the corresponding sub-band (m) from the frequency domain to the time domain for further sub-band processing.

Block array 432 represents a number (M) of OLS discard buffers 432-0 through 432-(M−1) such that, similar to block arrays 424, 426, 428 and 430 discussed above, there is one OLS discard buffer 432-m for each respective one (m) of the M number of sub-bands. Also like block arrays 424, 426, 428 and 430, while not all of blocks within the vertically depicted block array 432 shown in FIG. 3 are labeled with a reference numeral, it shall be understood that each depicted block within the illustrated block array 432 represents yet another OLS discard buffer 432-m among the OLS discard buffers 432-0 through 432-(M−1). Each given OLS discard buffer 432-m in this embodiment may be used to discard certain one or more of the samples received by the given OLS discard buffer 432-m, and to pass on within the CDEQ 250 the remaining samples. If for example the OLS ratio for the analysis bank portion 402 is ¼ (or 0.25), and a given IFFT-W block 430-m described above represents an IFFT size of W=128, then ¼ of the data output by the given IFFT-W block 430-m (i.e., 32 samples) should be discarded, and 96 samples should be retained and passed on within the CDEQ 250 for further processing.

After the analysis bank portion 402 of CDEQ 250, each respective one (m) of the M number of sub-bands enters a sub-band processing portion 404 of CDEQ 250. Block array 434 represents a number (M) of programmable delay units 434-0 through 434-(M−1) such that, similar to block arrays 424, 426, 428, 430 and 432 discussed above, there is one programmable delay unit 434-m for each respective one (m) of the M number of sub-bands. Each programmable delay unit 434-m in this embodiment may be used to introduce a pre-determined delay into its corresponding one (m) of the M number of sub-bands. The amount of introduced delay for a given one (m) sub-band, for example, may be determined based on one or more dependencies that for instance may include without limitation a measured amount of dispersion and/or a target level or value of dispersion compensation. In one example, each of the programmable delay units 434-0 through 434-(M−1) is configured to introduce either no delay or a respective associated delay, such that each (m) of the (M) number of sub-band signals are temporally aligned with one another upon exit from the block array 434. In this regard, the block array 434 serves to time-align the signals on different sub-bands, and thereby serves to compensate, at least in part, for chromatic dispersion across the M number of sub-bands.

After the sub-band processing portion 404 of CDEQ 250, each respective one (m) of the M number of sub-bands enters a synthesis bank portion 406 of CDEQ 250. Block array 436 represents a number (M) of OLS buffers 436-0 through 436-(M−1) such that, similar to the previously discussed block arrays, there is one OLS buffer 436-m for each respective one (m) of the M number of sub-bands. Also like some of the previously discussed block arrays, while not all of blocks within the vertically depicted block array 436 shown in FIG. 3 are labeled with a reference numeral, it shall be understood that each depicted block within the illustrated block array 436 represents yet another OLS buffer 436-m among the OLS buffers 436-0 through 436-(M−1).

Each OLS buffer 436-m in this embodiment may be used to introduce an amount of overlap between a given two consecutive FFT operations of length W samples, depending on the set OLS ratio of the synthesis bank portion 406. If for example the OLS ratio for the synthesis bank portion 406 is ¼ (or 0.25), and a given FFT-W block 438-m described below represents an FFT size of W=128, then a first of a given two consecutive FFT operations performed by the FFT-W block 438-m may use samples 0 to 127, and a second of the given two consecutive FFT operations performed by the FFT-W block 438-m uses samples 96 to 223, such that samples from 96 to 127 in this instance are used in both of the two consecutive FFT operations, resulting in an overlap of 32 samples.

The particular OLS ratio to which the OLS buffers 436-0 through 436-(M−1) are set is preferably also used to set other functional components of the synthesis bank portion 406 of CDEQ 250, such as for example the number (M) of static direct multipliers 440-0 through 440-(M−1), and the number (M) of rotation blocks 442-0 through 442-(M−1), each of which will be further described below. The select OLS ratio to which the afore-mentioned functional components of the synthesis bank portion 406 are set in this regard may be the same, but need not be the same, as the select OLS ratio to which the OLS buffer 410 and other above-mentioned functional components of the analysis bank portion 402 are set.

Block array 438 of the synthesis bank portion 406 represents a number (M) of FFT-W blocks 438-0 through 438-(M−1) such that, similar to previously described block arrays, there is one FFT-W block 438-m for each respective one (m) of the M number of sub-bands. Once again, while not all of blocks within the vertically depicted block array 438 shown in FIG. 3 are labeled with a reference numeral, it shall be understood that each depicted block within the illustrated block array 438 represents yet another FFT-W block 438-m among the FFT-W blocks 438-0 through 438-(M−1). Each FFT-W block 438-m in this embodiment may be used to convert the corresponding sub-band (m) from the time domain to the frequency domain for further sub-band processing by the synthesis bank portion 406.

Block array 440 of the synthesis bank portion 406 represents a number (M) of static multiplier blocks 440-0 through 440-(M−1) such that, similar to previously described block arrays, there is one static multiplier block 440-m for each respective one (m) of the M number of sub-bands. Once again, while not all of blocks within the vertically depicted block array 440 shown in FIG. 3 are labeled with a reference numeral, it shall be understood that each depicted block within the illustrated block array 440 represents yet another static multiplier block 440-m among the static multiplier blocks 440-0 through 440-(M−1). Static, or fixed, coefficients that may be selectively programmed for each static multiplier block 440-m in this embodiment may be used to further enhance the CD compensation range of the CDEQ 250.

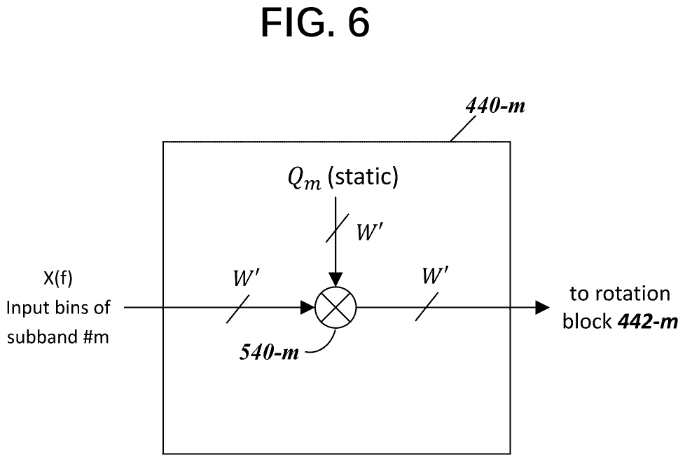

Each static multiplier block 440-m represents a set of static multipliers comprising W′ direct multipliers, denoted as Qₘ in a given block 440-m among the static multiplier block array 440, and thus static multiplier block array 440 comprises multiple sets of static multipliers, collectively denoted {Q₀, Q₁, . . . . Q_{M-1}}. A representative set of static multipliers 440-m is illustrated schematically for example in FIG. 6, as will be further discussed below. Each set of static multipliers 440-m serves to compensate, at least in part, for chromatic dispersion within its sub-band (m). Moreover, this use of static multiplier sets 440-0 through 440-(M−1) increases the available range of chromatic dispersion (CD) compensation in a power-efficient manner.

Continuing from left to right in the synthesis bank portion 406 of the CDEQ 250, next is a block array 442 representing a number (M) of rotation blocks 442-0 through 442-(M−1) such that, similar to various of the block arrays discussed above, there is one rotation block 442-m for each respective one (m) of the M number of sub-bands. Also like various of the block arrays discussed above, while not all of blocks within the vertically depicted block array 442 shown in FIG. 3 are labeled with a reference numeral, it shall be understood that each depicted block within the illustrated block array 442 represents yet another rotation block 442-m among the rotation blocks 442-0 through 442-(M−1). Each rotation block 442-m in this embodiment may introduce a pre-determined phase shift to the given sub-band (m) for which the rotation block 442-m is responsible.

A representative rotation multiplier 530-m that a given rotation block 442-m may represent is shown for example in FIG. 5. The amount of pre-determined phase shift introduced to a given sub-band (m) by the corresponding rotation block 442-m may vary from one sub-band to another, and for example may be determined based on one or more dependencies that for instance may include without limitation the center frequency bin of the given sub-band (m) and the applied OLS ratio. Depending on the center frequency bin allocation of the given sub-band (m) and the select OLS ratio, there can be phase discontinuities generated between successive FFT operations on a sub-band signal, whereupon the rotation block 442-m can be used to fix the phase discontinuities. As noted above, the amount of pre-determined phase shift introduced to a given sub-band (m) by the corresponding rotation block 442-m may also differ from the amount of pre-determined phase shift introduced to the same sub-band (m) by the corresponding rotation block 426-m that is discussed above.

Continuing towards the right-hand side of FIG. 3, the frequency multiplexer (Mux+Sum) 444 operates to gather the range of W′ frequency bins for each one (m) of the total number (M) of sub-bands processed by CDEQ 250, and sums the overlapping frequency bins between adjacent sub-bands so as to improve signal reconstruction. In particular, N≤W′*M frequency bins are generated from W*M frequency bins received by the Mux+Sum 444.

At the farther right-hand side of the synthesis bank portion 406 of CDEQ 250, the IFFT-N 446 receives a single data vector of length N that is output by the Mux+Sum 444. The IFFT-N 446 in turn converts the data to the time domain. Thereafter, the OLS discard buffer 448 may be used to discard certain one or more of the samples received by the OLS discard buffer 448, and to pass on the remaining samples as output of the CDEQ 250. If for example the OLS ratio for the synthesis bank portion 406 is ¼ (or 0.25), and the IFFT-N block 446 described above represents an IFFT size of N=2048, then ¼ of the data output by the given IFFT-N block 446 (i.e., 512 samples) should be discarded, and 1536 samples should be retained and passed as output of the CDEQ 250 for further processing within the DSP 206 in a conventional manner.

The signals output from the OLS discard buffer 448 (e.g., XI and XQ, in the case of CDEQ 250-1) are then further communicated within receiver DSP 206 such that the other illustrated components of receiver DSP 206, namely the adaptive PMD equalizer 260, the carrier phase recovery circuit 262, the demapper 264, the forward error correction circuit (FEC) 268, and the client processing circuit 270, may together operate in a conventional manner to enable the receiver DSP 206 deliver client data 210 via SERDES 208.

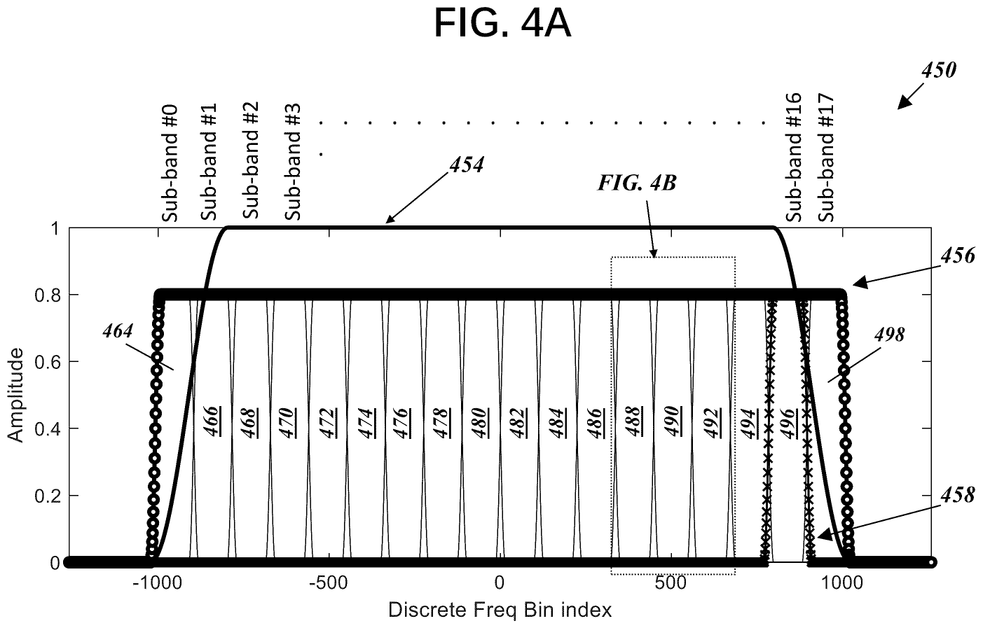

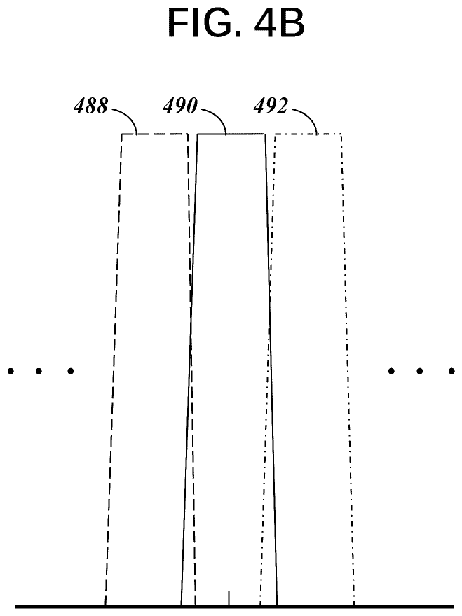

FIG. 4A is a representative spectra plot 450 illustrating example sub-band chromatic dispersion equalizer engine (CDEQ) operation of the CDEQ depicted in FIG. 3. In particular, the plot trace 454 depicts the representative single-carrier spectrum of the received optical signal in this example embodiment. Spanning from left to right across the plot are depicted sub-bands 464 (sub-band #0), 466 (sub-band #1), 468 (sub-band #2), 470 (sub-band #3), 472 (sub-band #4), 474 (sub-band #5), 476 (sub-band #6), 478 (sub-band #7), 480 (sub-band #8), 482 (sub-band #9), 484 (sub-band #10), 486 (sub-band #11), 488 (sub-band #12), 490 (sub-band #13), 492 (sub-band #14), 494 (sub-band #15), 496 (sub-band #16) and 498 (sub-band #17), illustrative of an example implementation wherein M=18 (i.e., m=0 through 17) and adjacent sub-bands overlap one another on the spectra plot.

FIG. 4B is a portion of the spectra plot of FIG. 4A, zoomed in on a representative three adjacent sub-bands of the spectra plot, namely sub-bands 488, 490 and 492, to more clearly illustrate an example of sub-band overlap between adjacent sub-bands that is characteristic across all of the number (M) of sub-bands. As a result of this overlap, N≤M*W, wherein W is the width (in bins) of each IFFT-W block 430-m. The smaller this overlap is between adjacent sub-bands, the more efficient the circuit is. This approach of sub-band overlap between adjacent sub-bands helps to at least mitigate if not eliminate distortions that may otherwise result from known prior art techniques that deconstruct a signal into sub-bands for chromatic dispersion processing, and then reconstruction the signal from such sub-bands. This approach of sub-band overlap as described in relation to the example embodiments herein in turn helps to enable a more precise reconstruction of the signal as compared to known prior art techniques, even though the approach may increase circuit complexity.

Returning back to FIG. 4A, the plot trace 458 depicted using “x” marks illustrates for example the amplitude response of the filtering applied on sub-band 496 (sub-band #16) as a result of the Dₘ and Hₘ filtering coefficients programmed in relation to programmable Dₘ/Hₘ multipliers 424-m, wherein m=16. Moreover, the plot trace 456 depicts for example a representative combined amplitude response of the filtering applied using all 18 of the sub-bands 464-498 (sub-bands #0-#17) as a result of the Dₘ and Hₘ filtering coefficients programmed in relation to all 18 sets of programmable Dₘ/Hₘ multipliers 424-0 through 424-(M−1), wherein M=18. In this regard, all 18 individual sub-band amplitude responses of the sub-bands 464-498 (sub-bands #0-#17) can be summed together to generate an overall amplitude response shown by plot trace 456 in FIG. 4A, which can be achieved using a Raised Cosine function of a certain alpha factor.

FIG. 6 is a schematic block diagram further depicting an example embodiment of a set of W′ static direct multipliers 440-m representing any given one of the sets of static direct multipliers 440-0 through 440-(M−1) in the sub-band chromatic dispersion equalizer engine (CDEQ) 250 shown in FIG. 3. In the example illustrated in FIG. 6, input bins of a representative sub-band #m (or (m)) are in this example illustration applied to the depicted set of W′ static direct multipliers 540-m. The static coefficients (Qₘ) selected for the sets of static direct multipliers 440-0 through 440-(M−1) are, in the context of the sub-band chromatic dispersion equalizer engine (CDEQ) 250 shown in FIG. 3, preferably defined to provide a net flat amplitude or magnitude response over as wide range of frequency as reasonably possible. They may also be pre-determined for example to statically apply half of the total targeted amount of CD equalization (i.e., Dₘₐₓ/2) (or chromatic pre-dispersion, in the case of a transmitter for example) for the CDEQ 250. Insofar as a static multiplier generally speaking consumes much less power than a programmable multiplier, the use of sets of static direct multipliers 440-0 through 440-(M−1) in the synthesis bank portion 406 of CDEQ 250 to carry half the targeted maximum CD compensation (Dₘₐₓ/2) provides for a more power-efficient ASIC implementation without sacrificing the CD compensation range.

FIG. 7 is a schematic block diagram further depicting an example embodiment of a set of programmable Direct (D)/Hermitian (H) (Dₘ/Hₘ) multipliers 424-m representing any given one of the sets of programmable Dₘ/Hₘ multipliers 424-0 through 424-(M−1) in the sub-band chromatic dispersion equalizer engine (CDEQ) 250 shown in FIG. 3. In particular, the illustrated set of W′ programmable Dₘ/Hₘ multipliers 424-m is configured to receive from the demux 422 input bins of a given sub-band (m), which in turn are applied to a set of W′ direct (Dₘ) multipliers 504-m. The illustrated set of W′ programmable Dₘ/Hₘ multipliers 424-m is further configured to receive from the demux 422 mirrored-frequency input bins of the given sub-band (m), which in turn are conjugated by a set of W′ conjugators 508-m and applied to a set of W′ Hermitian (Hₘ) multipliers 510-m. For each of the W′ pairs of multipliers 504-m and multipliers 510-m, output from the direct (Dₘ) multipliers 504-m and output from the Hermitian (Hₘ) multipliers 510-m are summed by a given one of the sets of W′ adders 512-m and delivered as output of the set of W′ programmable Direct (D)/Hermitian (H) (Dₘ/Hₘ) multipliers 424-m.

In the example illustrated in FIG. 7, with its reference to a simplified, rotated version of the spectra plot 450 of FIG. 4A, input bins of sub-band #12 (i.e., m=12) are in this example illustration applied to the depicted set of W′ direct (Dₘ) multipliers 504-m (504-12, in this example). Continuing further with this same example illustration, insofar as the input bins of sub-band #5 are deemed to be the mirrored input bins of sub-band #12 (m=12) relative to frequency 0 along the x-axis of the spectra plot 450, input bins of sub-band #5 are also conjugated by a set of W′ conjugators 508-m (508-12, in this example), and applied to a set of W′ Hermitian (Hₘ) multipliers 510-m (510-12, in this example).

The Dₘ and Hₘ filtering coefficients programmed for the sets of programmable Dₘ/Hₘ multipliers 424-0 through 424-(M−1) are, in the context of the sub-band chromatic dispersion equalizer engine (CDEQ) 250 shown in FIG. 3, preferably defined to provide a net flat amplitude or magnitude response over as wide range of frequency as reasonably possible. They may also be programmed for example to apply programmable CD equalization (or chromatic pre-dispersion, in the case of a transmitter for example) in the range [−Dₘₐₓ/2, Dₘₐₓ/2] which, in combination with the static CD compensation in the amount of Dₘₐₓ/2 described above in the context of the synthesis bank portion 406 coefficients (Qₘ) of the set of static direct multipliers 440-m, enables the CDEQ 250 to compensate CD for example in the range [0, Dₘₐₓ]. Further, these sets of programmable Dₘ/Hₘ multipliers 424-0 through 424-(M−1) may be also programmed for example to apply compensation of some or all IQ impairments from the optical receiver 202 front-end (e.g., IQ skew, IQ quadrature error, bandwidth emphasis, IQ power mismatches, IQ frequency mismatches, etc.).

From the foregoing description of FIGS. 3-7 in the example context of CDEQ 250-1, in relation to signals having polarization states XI and XQ, it will be apparent to those skilled in the art that the same example embodiment apparatus and methods apply equally in the example context of CDEQ 250-2, for signals having polarization states YI and YQ, for example.

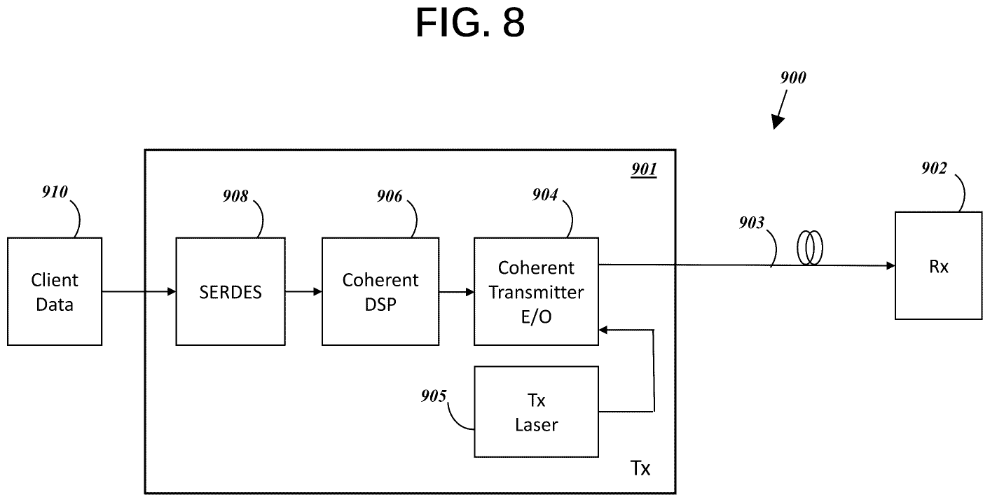

FIG. 8 is another block diagram schematically depicting an example embodiment of a representative transmit-and-receive, single-carrier optical signal networking system, including without limitation example embodiments of a coherent optical transmitter 901 and of a coherent optical receiver 902. The coherent optical transmitter 901 comprises traditional transmitter components, such as for example transmit laser 905, coherent transmitter E/O 904, coherent DSP 906 and SERDES 908. The coherent optical transmitter 901 for example facilitates communication of client data 910 to optical receiver 902 across one or more optical fiber 903.

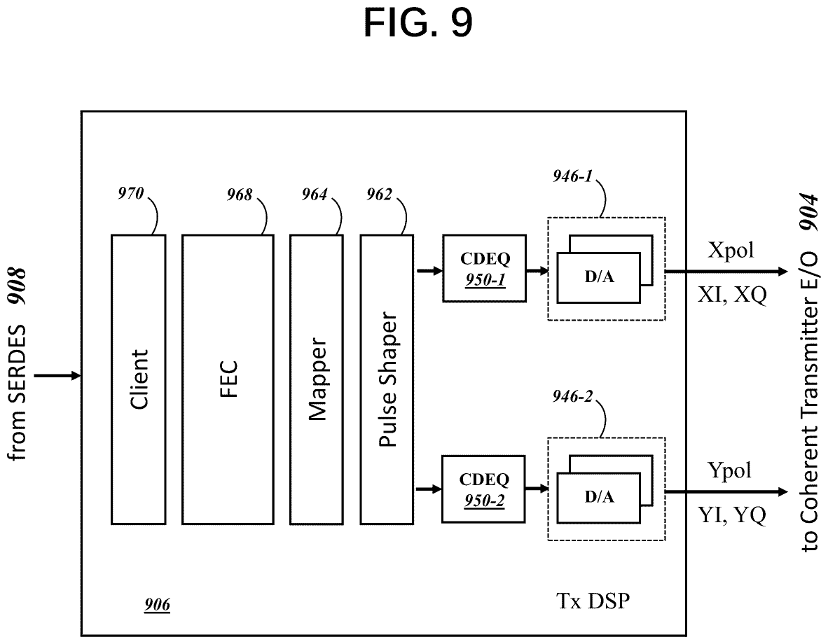

FIG. 9 is a schematic block diagram further depicting an example embodiment of a transmitter digital signal processor (DSP), including example sub-band chromatic dispersion equalizer engines (CDEQs) 950-1 and 950-2 and certain other components thereof that are of a conventional nature, that belongs to the coherent DSP 906 depicted within the coherent optical transmitter 901 shown in FIG. 8. Such other components include for example the client processing circuit 970, the forward error correction circuit (FEC) 968, the mapper 264, the pulse shaper 962, and D/A (i.e., A/D) converters 946-1 and 946-2.

From the foregoing description of FIGS. 1-7 in the example context of optical receiver 202, it will be apparent to those skilled in the art that the example embodiment apparatus and methods described above in relation to CDEQ 250-1 and CDEQ 250-2 apply equally in the example embodiment context of an optical transmitter 901 comprising example sub-band chromatic dispersion equalizer engines (CDEQs) CDEQ 950-1 and CDEQ 950-2, as shown for example in FIGS. 8 and 9. In this regard, it will be understood that each of CDEQ 950-1 and CDEQ 950-2 can be constructed and operated similarly to CDEQ 250-1 and CDEQ 250-2, respectively, but effectively in reverse so as to chromatically pre-disperse the signal at the input side of the transmission optical fiber prior to transmission to an optical receiver. Pulse shaper 962 operates to convert for example the client data symbols to an oversampled signal with a defined pulse shape. This resulting pulse shape helps to define the spectral content of the signal on which the CDEQs operate to perform chromatic pre-distortion.

While optical transmission networks 200 and 900 are separately shown and described herein, it will be understood that a given optical transmission network (not shown) may embody the characteristics and attributes of both example optical transmission networks 200 and 900, and as a result for example a given example embodiment optical transceiver of such an optical transmission network may be configured, using apparatus and methods consistent with the present invention, to both (a) perform sub-band chromatic dispersion equalization on an optical signal received from the optical transmission network, and (b) perform sub-band chromatic pre-dispersion on a signal prior to transmission to the optical transmission network.

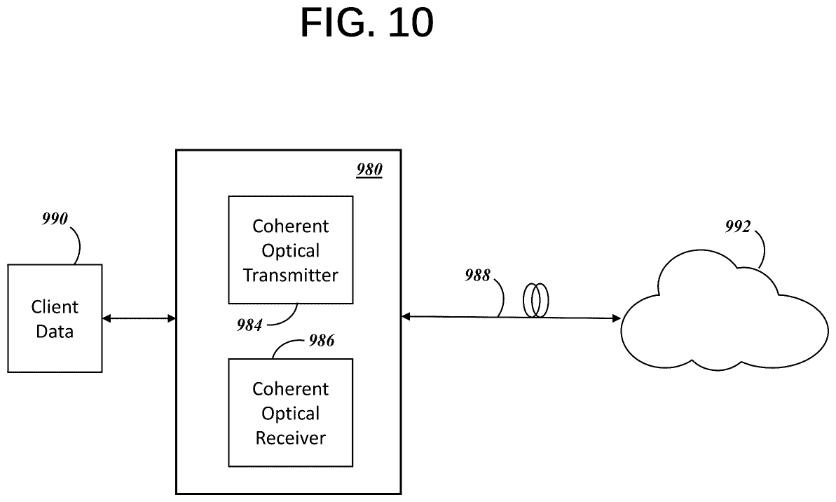

For example, FIG. 10 depicts, in yet another example embodiment, a coherent optical transceiver 980 comprising both a coherent optical transmitter portion 984 and a coherent optical receiver portion 986. Transceiver 980 for example facilitates bidirectional communication (whether on the same fiber, or on two distinct fibers) of client data 990 to/from an optical network 992 across one or more optical fiber 988. Coherent optical receiver portion 986 for example may comprise apparatus and methods described herein for chromatic dispersion equalization, consistent for example with the above-described apparatus and methods of optical receiver 202. Moreover, coherent optical transmitter portion 984 for example may comprise apparatus and methods described herein for chromatic pre-dispersion, consistent for example with the above-described apparatus and methods of optical transmitter 901.

As will be apparent to those skilled in the art, various of these optical transceiver components and functions may be consolidated in a given optical transceiver implementation, such as for example a coherent DSP device that performs both transmit and receive DSP functions, as well as DAC and ADC functions. Another example of such consolidated components and functions may be an optical engine that that performs both transmit E/O and receive O/E functions. Further, one or more example embodiments of transceiver 980 for example may be a pluggable device, at least one or more of such pluggable embodiments may adhere to form factors including for example but without limitation C form factors (e.g., CFP, CFP2, etc.), QSFP form factors (QSFP and QSFP-DD), and other form factors known to those skilled in the art.

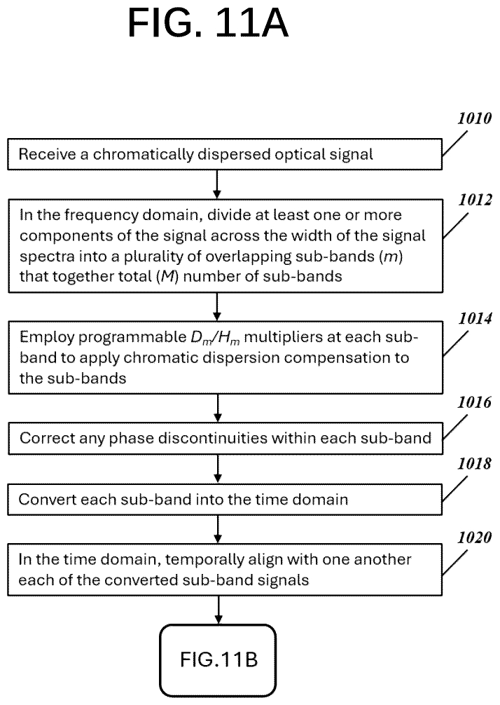

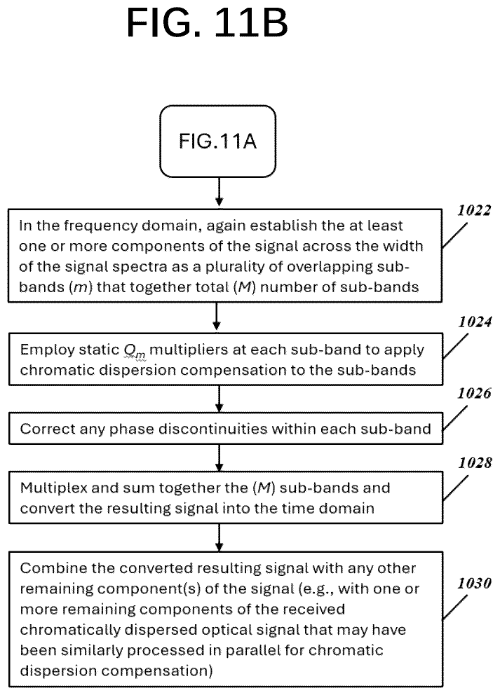

FIGS. 11A and 11B together form one flow diagram representing various steps of an example embodiment of the present invention. In particular, in step 1010, a chromatically dispersed optical signal is received. In step 1012, in the frequency domain, at least one or more components of the signal are divided across the width of the signal spectra into a plurality of overlapping sub-bands (m) that together total (M) number of sub-bands. In step 1014, programmable Dₘ/Hₘ multipliers are employed at each sub-band to apply chromatic dispersion compensation to the sub-bands. In step 1016, any phase discontinuities within each sub-band are corrected. In step 1018, each sub-band is converted into the time domain. In step 1020, in the time domain, each of the converted sub-band signals are temporally aligned with one another. In step 1022, in the frequency domain, again establish the at least one or more components of the signal across the width of the signal spectra as a plurality of overlapping sub-bands (m) that together total (M) number of sub-bands. In step 1024, static Qₘ multipliers are employed at each sub-band to apply chromatic dispersion compensation to the sub-bands. In step 1026, any phase discontinuities within each sub-band are corrected. In step 1028, the (M) sub-bands are multiplexed and summed together and converted into the time domain. In step 1030, the converted signal is combined with any other remaining component(s) of the signal (e.g., with one or more remaining components of the received chromatically dispersed optical signal that may have been similarly processed in parallel for chromatic dispersion compensation). From the disclosure provided herein it will be understood by those skilled in the art that additional flow diagrams can be generated using this disclosure, such additional flow diagrams for example having different, fewer and/or additional steps than those set forth in FIGS. 11A and 11B. Such additional flow diagrams may include for example and without limitation additional flow diagrams representing steps for performing chromatic dispersion equalization on a received signal, as well as flow diagrams representing steps for performing chromatic pre-dispersion on a signal to be transmitted.

Moreover, from the foregoing description of FIGS. 1-11 in the example contexts of single-carrier optical transmission networks 200 and 900 it will be apparent to those skilled in the art that apparatus and methods consistent with the present invention may also be used at least for purposes of chromatic dispersion equalization and/or chromatic pre-dispersion, or in other words chromatic dispersion compensation, in point-to-point optical transmission systems comprising digital subcarriers.

Although at least certain of the example embodiments are described herein as comprising a DSP, it will be understood by those skilled in the art that other processor examples may be instead or additionally employed, which may include a device such as for example but without limitation a single- or multi-core processor, a special purpose processor, a conventional processor, a Graphics Processing Unit (GPU), a central processing unit (CPU), a microprocessor, a multi-core processor, a microprocessor in association with a DSP core, a controller, a microcontroller, an application specific integrated circuit (ASIC), a Field Programmable Gate Array (FPGA) circuit, any other type of integrated circuit (IC), a system-on-a-chip (SOC), a state machine, or a similar type of device. A given processor may be or include any one or several of these devices, including combinations thereof. Any of such processors may access one or more data storage devices and/or interfaces, as well as one or more non-transitory processor-readable medium (e.g. a system memory) storing processor-executable code and/or software application(s). The system memory may for example store a software application that, when executed by the processor, causes an embodiment of the present invention to perform an action such as communicate with, or control, one or more components of the embodiment, and/or another device and/or system outside of the embodiment, and/or to perform an action such as one or more of those actions described herein in relation to the present invention.

Although the exemplary embodiments of the present disclosure are described above in detail with reference to the accompanying drawing(s), the present disclosure is not limited thereto and may be embodied in different forms and combinations apparent to those skilled in the art, based on the teachings hereof, without departing from the technical concept of the present disclosure. The exemplary embodiments of the present disclosure are provided for illustrative purposes only and are not intended to limit the technical concept of the present disclosure. Therefore, it should be understood that the above-described exemplary embodiments are illustrative in all aspects and do not limit the present disclosure.

Even though particular combinations of features are disclosed in the specification, these combinations are not intended to limit the disclosure. In fact, features may be combined in ways not specifically disclosed in the specification, as will be apparent to those skilled in the art based on the teachings hereof.

No element, act, or instruction used in the present disclosure should be construed as critical or essential to the invention unless explicitly described as such. Further, the phrase “based on” is intended to mean “based, at least in part, on” unless explicitly stated otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements, components and/or aspects of the embodiments herein. This is done merely for convenience and to give a general sense of the inventive concept. This description should be read to include one or more and the singular also includes the plural unless it is obvious that it is meant otherwise.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

What is claimed is:

1. An apparatus for chromatic dispersion compensation, comprising a chromatic dispersion equalizer configured to divide at least one or more components of a received optical signal into a plurality of overlapping sub-bands (m) that together total (M) number of sub-bands.
